(19) United States
(12) Patent Application Publication
(10) Pub. No.: US 2008/0196450 A1
(43) Pub. Date: Aug. 21, 2008

(54) COATED OPTICAL FIBER ENDFACE PREPARATION METHOD AND TOOL

(75) Inventors: Kazuo Hogari, Tsukuba-shi (JP); Noriyoshi Matsumoto, Tsukuba-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: Nippon Telegraph and Telephone Corporation, Tokyo (JP)

(21) Appl. No.: 11/850,538

(22) Filed: Sep. 5, 2007

(30) Foreign Application Priority Data
Feb. 21, 2007 (JP) 2007-041061
Jun. 4, 2007 (JP) 2007-148652

(51) Int. Cl. G02B 6/25; H05B 3/48

(52) U.S. Cl. 65/452; 219/544; 65/406

(57) ABSTRACT

As the endface preparation of the coated optical fiber, cutting using thermal stress is carried out, and a ceramic heater is used as a heat source, thereby making it possible to provide a coated optical fiber endface preparation method and tool capable of increasing the cutting success rate of the coated optical fiber. The coated optical fiber is removed of its coating to obtain the bare optical fiber. The bare optical fiber is heated by the heat source consisting of the ceramic heater, and is cut by further adding stress to part of the bare optical fiber which has been provided with the thermal stress. When heating the bare optical fiber, the product of a temperature and the heating time of the heat source is made 3000° C. sec or more.

### CROSS-REFERENCE TO RELATED APPLICATIONS

This application claims the benefit of Japanese Patent Application Nos. 2007-041061 filed in Feb. 21, 2007, and Nos. 2007-148652 filed in Jun. 4, 2007, which are hereby incorporated by reference herein in their entirety.

### BACKGROUND OF THE INVENTION

1. Field of the Invention

The present invention relates to a coated optical fiber endface preparation method and tool, and more particularly to a coated optical fiber endface preparation method and tool for carrying out coating removal of a coated optical fiber, surface cleaning of the bare optical fiber, and cutting of the bare optical fiber using thermal stress.

2. Description of Related Art

Recently, an increasing number of users have been provided with broadband services using optical fibers, and hence construction and maintenance of access optical transmission lines economically and efficiently have become a matter of great urgency. To construct optical access networks, an enormous number of optical fibers must be joined to each other, and efficient joints of the optical fibers have become one of the most important tasks.

At present, as preparation for joining optical fibers, there are such procedures of endface preparation as: (1) coating removal; (2) fiber surface cleaning; and (3) fiber endface cutting, followed by (4) joining processing.

More specifically, flat surfaces necessary for joints are obtained conventionally by: (1) removing plastic coatings covering the optical fibers using a coating removal tool for exclusive use; (2) cleaning the fiber surfaces by removing residual fiber coatings remaining thereon using paper containing alcohol after the coating removal; and (3) cutting after scoring the fiber surfaces with a blade. After that, (4) the optical fibers are joined by means of mechanical splice, MT connectors, fusion splice (see, Takuo Kikuchi and Koichi Nishizawa, “FTTH Construction Technology Supporting Optical Communication Age” The Optronics Co. Ltd., Jul. 6, 2004, pp. 68-127).

In addition, as endface preparation technology of optical fibers, a method of cutting by adding thermal stress to the optical fibers is proposed. According to the method, the optical fibers are cut by the thermal stress caused by heating the fiber surfaces rather than by scoring the fiber surfaces. The heat source used for heating the fiber surfaces can cause the residual coatings on the fiber surfaces to be burned down after the coating removal, thereby being able to clean the surfaces of the fibers. This makes it possible to carry out the optical fiber endface preparation consisting of the cutting and cleaning of the optical fibers with a single tool. Thus, the simplification and speedup of the optical fiber joint operations is expected (see, Japanese patent laid-open No. 2007-101911; and Noriyoshi Matsumoto and Kazuo Hogari, “Investigation of integrated optical fiber joint tool”, Proceedings of the 2006 IEICE General Conference, The Institute of Electronics, Information and Communication Engineers of Japan, Mar. 8, 2004, p. 498).

However, the optical fiber cables used for access networks are composed of a fiber ribbon with four or eight coated fibers. The fiber ribbons can be joined efficiently by using the mass splice or MT (mechanically transferable) connector techniques. However, using the endface preparation tool utilizing the heat source for fiber ribbon will occur to reduce the cutting success rate.

The cutting success rate is defined in terms of whether the specifications of the fusion splice machine are satisfied. Specifically, when the bare optical fibers are set on the fusion splice machine and are spliced successfully, a decision of cutting success is made. One of the reasons the cutting success rate reduces is that when Nichrome wire is used as the heat source, several bare optical fibers in fiber ribbon do not make contact with the Nichrome wire in the same conditions because of deforming and curving of the Nichrome wire due to thermal expansion. This will prevent the heat from being uniformly added to the several bare optical fibers in fiber ribbon, and causes a shortage of the thermal stress on the bare optical fibers. As a result, such cases are likely to occur where some bare optical fibers in the fiber ribbon are not cut or cannot be spliced because of the large endfaces position variance. Therefore, it has a problem in that it cannot be used in practice because of the low cutting success rate for fiber ribbon.

Furthermore, to cut the coated optical fibers by the thermal stress, it has not been made clear to what extent the heat source should add its heat to achieve stable and precise cutting. This presents a problem in that a shortage of the heating will make the cut endfaces rough, and that to add the enough heat, the heating takes a long time and decreases efficiency. Although the optical fiber cutting based on the thermal stress can be conjectured by a theoretical equation, the cutting used for the optical fiber joints must be mirror surface cutting, and the conditions thereof have not been proved up to now.

### SUMMARY OF THE INVENTION

The present invention is implemented to solve the foregoing problems. It is therefore an object of the present invention to provide an optical fiber endface preparation method and tool capable of increasing the cutting success rate by employing a ceramic heater as a heat source for the cutting using the thermal stress as the endface preparation, especially to fiber ribbon. Another object of the present invention is to provide a coated optical fiber endface preparation method and tool capable of achieving a high cutting success rate at high speed by carrying out cutting based on heating conditions which are required for the mirror surface cutting and determined experimentally.

To accomplish these objects, the present invention is, which is characterized by comprising: an optical fiber endface cutting method comprising a cutting step of cutting the bare optical fiber with thermal stress by using a heat source composed of a ceramic heater after the fiber coating removal and fiber surface cleaning.

In the optical fiber endface cutting method, the ceramic heater may consist of a heating element embedded in ceramics.

In the optical fiber endface cutting method, the ceramic heater may consist of Nichrome wire or tungsten wire embedded in ceramics.

In the optical fiber endface cutting method, the cutting step may a heating step of heating a prescribed local area of the bare optical fiber by said heat source composed of the ceramic heater; and a pressurizing step of further applying bending or tension stress on the prescribed local area of the bare optical fiber to carry out cutting, which the prescribed local area is provided the thermal stress by said heating step.

In the optical fiber endface cutting method, a product of a temperature and heating time of said heat source may be 3000° C. sec or more.

A coated optical fiber endface cutting tool in accordance with the present invention comprising: a fiber holder for clamping a bare optical fiber; a clamp section set and held in said fiber holder for clamping the bare optical fiber after the fiber coating removal and fiber surface cleaning; a heat source composed of a ceramic heater placed in the moving region of the coated optical fiber held in said fiber holder for heating a prescribed local area of the bare optical fiber clamped by said clamp section; and a stress component for further applying bending or tension stress on the prescribed local area of the bare optical fiber, which the prescribed local area is provided the thermal stress by said heat source composed of the ceramic heater.

In the optical fiber endface cutting tool, the ceramic heater may consist of a ceramic heater having a heating element embedded in ceramics.

In the optical fiber endface cutting tool, the ceramic heater may consist of a ceramic heater having Nichrome wire or tungsten wire embedded in ceramics.

In the optical fiber endface cutting tool, a product of a temperature and heating time of said heat source may be 3000° C. sec or more.

A coated optical fiber endface preparation method in accordance with the present invention comprises: a coating removal step of removing a coating of a coated optical fiber to obtain a bare optical fiber; and a cutting step of cutting the bare optical fiber with the thermal stress by using a heat source composed of a ceramic heater.

In the optical fiber endface preparation method, the ceramic heater may consist of a ceramic heater having a heating element embedded in ceramics.

In the optical fiber endface preparation method, the ceramic heater may consist of a ceramic heater having Nichrome wire or tungsten wire embedded in ceramics.

In the optical fiber endface preparation method, the coating removal step may comprise: a heating step to heat the fiber coating for stripping easily; a stripping step for stripping a fiber coating of the coated optical fiber with a blade.

In the optical fiber endface preparation method, the cutting step may comprise: a heating step of heating a prescribed local area of the bare optical fiber by said heat source composed of the ceramic heater; and a pressurizing step of further applying bending or tension stress on the prescribed local area of the bare optical fiber to carry out cutting, which the prescribed local area is provided the thermal stress by said heating step.

In the optical fiber endface preparation method, a product of a temperature and heating time of the heat source may be 3000° C. sec or more.

An optical fiber endface preparation tool in accordance with the present invention comprises: a fiber holder for clamping a coated optical fiber; a base having a sliding section for sliding said fiber holder in an axial direction of the coated optical fiber; a heating section which is set for heating the fiber coating removal portion of the coated optical fiber for removing easily; a blade placed for removing the fiber coating which is heated by said heating section; a clamp section which is set for clamping the bare optical fiber which is removed the fiber coating of the coated optical fiber by said blade; a heat source composed of a ceramic heater which is set for heating a prescribed local area of the bare optical fiber clamped by said clamp section; and a stress component for further applying bending or tension stress on the heated section of the bare optical fiber whose prescribed section is heated by said heat source composed of the ceramic heater, which the prescribed local area is provided the thermal stress by said heat source composed of the ceramic heater.

In the optical fiber endface preparation tool, the ceramic heater may consist of a ceramic heater having a heating element embedded in ceramics.

In the optical fiber endface preparation tool, the ceramic heater may consist of a ceramic heater having Nichrome wire or tungsten wire embedded in ceramics.

In the coated optical fiber endface preparation tool, a product of a temperature and heating time of the heat source may be 3000° C. sec or more.

According to the present invention, employing the ceramic heater as the heat source for the all-in-one tool that carries out the endface preparation of the optical fiber such as the coating removal, surface cleaning and cutting makes it possible to increase the cutting success rate of the optical fiber. Thus using a simplified compact tool enables tool setting in a short time for joint operation of the coated optical fibers in a small space such as on a pole or in a manhole.

In addition, the present invention determines the optical fiber cutting condition in terms of the product of the temperature and heating time of the heat source. Accordingly, it may achieve mirror surface cutting stably and quickly, thereby enabling smooth joint operation.

Furthermore, the present invention is applicable not only to a plurality of coated optical fibers of the fiber ribbon, but also to a mono coated optical fiber.

Further features of the present invention will become apparent from the following description of exemplary embodiments (with reference to the attached drawings)

### BRIEF DESCRIPTION OF THE DRAWINGS

FIG. 1 is a schematic perspective view showing a fiber endface preparation tool of an embodiment in accordance with the present invention;

FIG. 2 is a schematic exploded perspective view showing the fiber endface preparation tool of the embodiment in accordance with the present invention;

FIG. 3 is a schematic perspective view showing a coated fiber holder of the embodiment in accordance with the present invention;

FIG. 4 is a schematic front view showing the operation of the fiber endface preparation tool of the embodiment in accordance with the present invention;

FIG. 5 is a schematic front view showing the operation of the fiber endface preparation tool of the embodiment in accordance with the present invention;

FIG. 6 is a schematic front view showing the operation of the fiber endface preparation tool of the embodiment in accordance with the present invention;

FIG. 7 is a schematic front view showing the operation of the fiber endface preparation tool of the embodiment in accordance with the present invention;

FIG. 8 is a schematic front view showing the operation of the fiber endface preparation tool of the embodiment in accordance with the present invention;

FIG. 9 is a schematic front view showing the operation of the fiber endface preparation tool of the embodiment in accordance with the present invention;

FIG. 10 is a characteristic diagram illustrating a cutting success rate of the bare optical fibers that undergo the endface preparation by the fiber endface preparation tool of the embodiment as compared with Nichrome wire example;

FIG. 11 is a characteristic diagram illustrating the fusion splice losses using 4-fiber ribbon that undergo the endface preparation by the fiber endface preparation tool of the embodiment as compared with those of the conventional example;

FIG. 12 is a characteristic diagram illustrating the connection losses of MT connector using 4-fiber ribbon that undergo the endface preparation by the fiber endface preparation tool of the embodiment in accordance with the present invention as compared with those of the conventional example;

FIG. 13 is a photograph showing bare optical fibers after the surface cleaning of FIG. 5;

FIG. 14 is a perspective view of a fiber cutting tool used for experiment in accordance with the present invention;

FIG. 15 is a side view when the coated optical fibers are set in the holder;

FIG. 16 is a side view when the coated optical fibers are cut with a stress plate after heating;

FIG. 17 is a graph illustrating success rates when a mono coated optical fiber is cut by the cutting tool of FIG. 14; and

FIG. 18 is a graph illustrating success rates when 4-fiber coated optical fibers are cut by the cutting tool of FIG. 14.

### DESCRIPTION OF THE EMBODIMENTS

The embodiments of the invention will now be described with reference to the accompanying drawings.

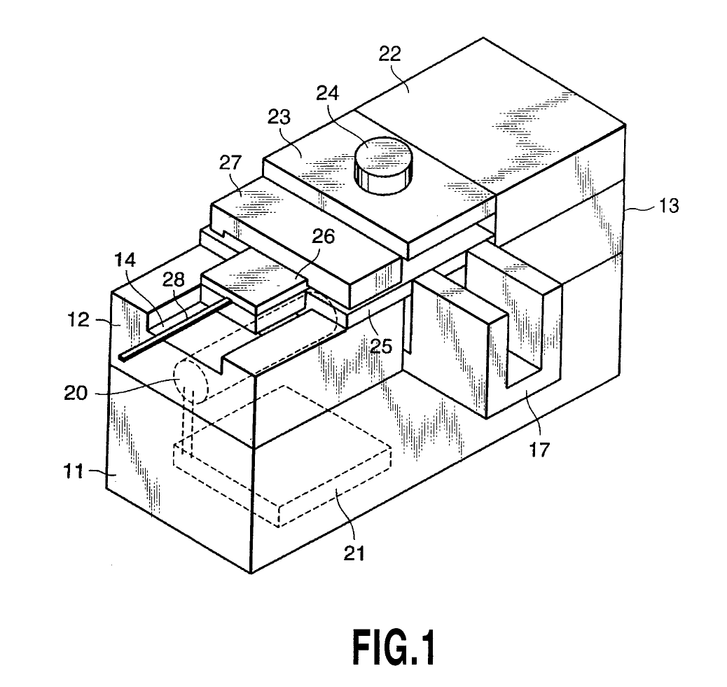

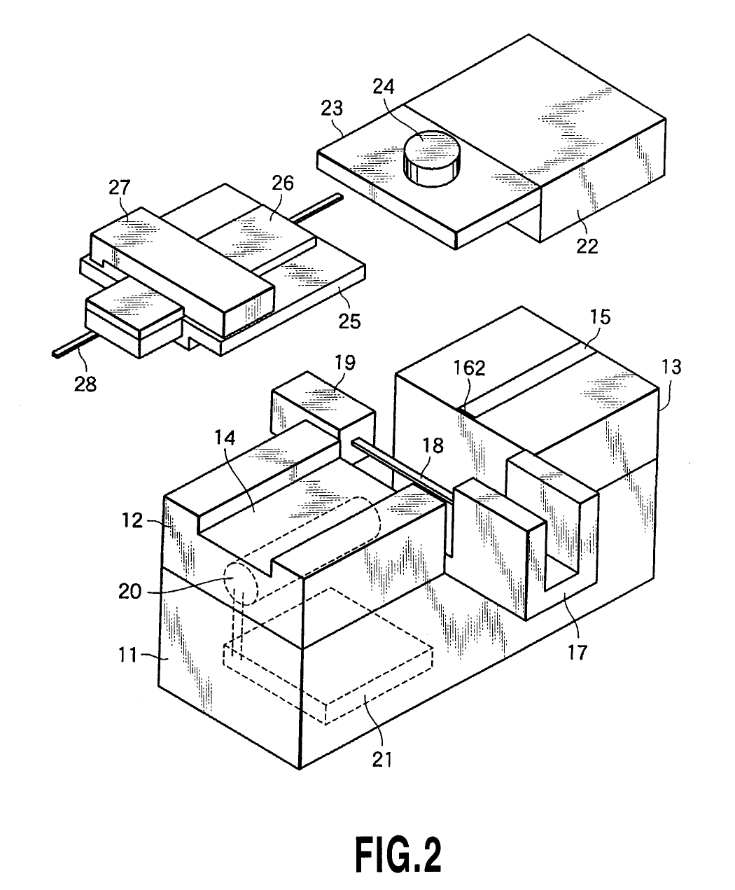

FIG. 1 is a schematic perspective view showing a fiber endface preparation tool of an embodiment in accordance with the present invention; and FIG. 2 is a schematic exploded perspective view showing the fiber endface preparation tool of the embodiment in accordance with the present invention.

As shown in FIG. 1 and FIG. 2, on the front top of a base 11 consisting of a nearly rectangular box, a holder mounting section sliding part 12 is mounted; and on the rear top of the base 11, a fiber coating removal part 13 is mounted with leaving a space between it and the holder mounting section sliding part 12.

On the top surface of the holder mounting section sliding part 12, a guide groove 14 is cut in the longitudinal direction; and on the top surface of the fiber coating removal part 13, a fiber coating heating section 15 is provided in the longitudinal direction. At the front end of the fiber coating heating section 15, a lower blade for coating removal 162 is provided.

Between the holder mounting section sliding part 12 and the fiber coating removal part 13, a clamp part 17 with nearly a U-shaped section is insertably and removably mounted. In the clamp part 17, a heat source 18 consisting of a ceramic heater is mounted and supported by a supporting component 19. The heat source 18 is provided in such a manner as to be moved in the vertical direction by a heating section vertically driving motor 20. The heating section vertically driving motor 20 is connected to an electric circuit 21 which has a preset program installed, and controls the vertical movement of the heat source 18 via the heating section vertically driving motor 20. The heating section vertically driving motor 20 and electric circuit 21 are built in the base 11.

On the top surface of the fiber coating removal part 13, a cover 22 is placed in such a manner as to cover the fiber coating heating section 15 and the lower blade for coating removal 162. The cover 22 is provided with an upper blade for coating removal 161 (not shown) placing opposite the lower blade for coating removal 162. To the cover 22, a stress applying component fixing plate 23 is integrally attached in such a manner as to fill up the space between the holder mounting section sliding part 12 and the fiber coating removal part 13. To the stress applying component fixing plate 23, a stress applying component 24 is provided in such a manner that it passes through the stress applying component fixing plate 23 and moves freely in the vertical direction.

On the holder mounting section sliding part 12, a holder mounting section 25 is placed slidably along the guide groove 14. On the holder mounting section 25, a coated fiber holder 26 is attached by opening and closing a holder mounting section upper cover 27. In the coated fiber holder 26, a fiber ribbon 28 is placed and clamped.

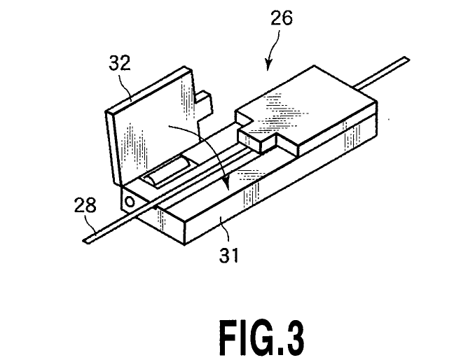

FIG. 3 is a schematic perspective view showing the coated fiber holder 26 of the embodiment in accordance with the present invention. As shown in FIG. 3, on a holder body 31 of the coated fiber holder 26, an upper cover 32 is placed in a freely openable and closable manner. By opening and closing the upper cover 32, the fiber ribbon 28 with the several coated optical fibers is clamped between the holder body 31 and the upper cover 32.

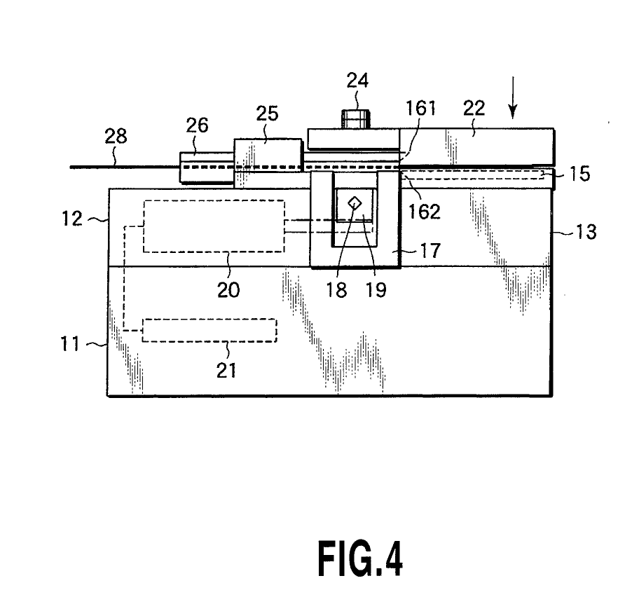

FIG. 4-FIG. 9 are schematic front views showing the operation of the fiber endface preparation tool of the embodiment in accordance with the present invention. More specifically, as shown in FIG. 4, after mounting the coated fiber holder 26, which holds the fiber ribbon, on the holder mounting section 25, the holder mounting section 25 is placed on the guide groove 14 of the holder mounting section sliding part 12, and is slid in the axial direction of the fiber ribbon 28 so as to bring it closer to the fiber coating removal part 13. In this case, part of the coated optical fibers 28 is placed on the fiber coating heating section 15 of the fiber coating removal part 13. After that, the cover 22 is closed on the fiber coating removal part 13, and the upper blade for coating removal 161 attached to the cover 22 is fixed in such a manner as to bite the coated optical fibers 28 with the lower blade for coating removal 162. In this case, the fiber ribbon 28 placed on the fiber coating heating section 15 is heated to facilitate the coating removal.

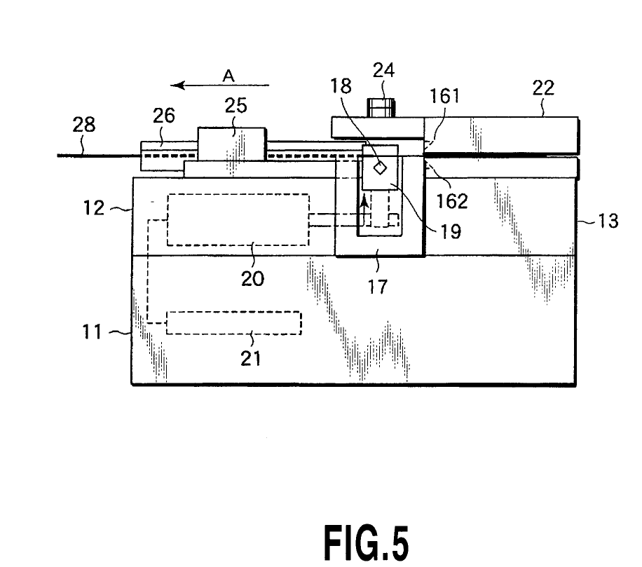

Next, as shown in FIG. 5, the holder mounting section 25, which holds the fibers ribbon 28, is slid forward (in the direction of arrow A) in the condition the cover 22 is closed. Thus, the fiber coating of the fiber ribbon 28 removes using the upper blade for coating removal 161 and the lower blade for coating removal 162 in a scraped off manner. Then, the residual coatings remaining on the bare optical fibers in the fiber ribbon are removed by passing them near the heat source 18.

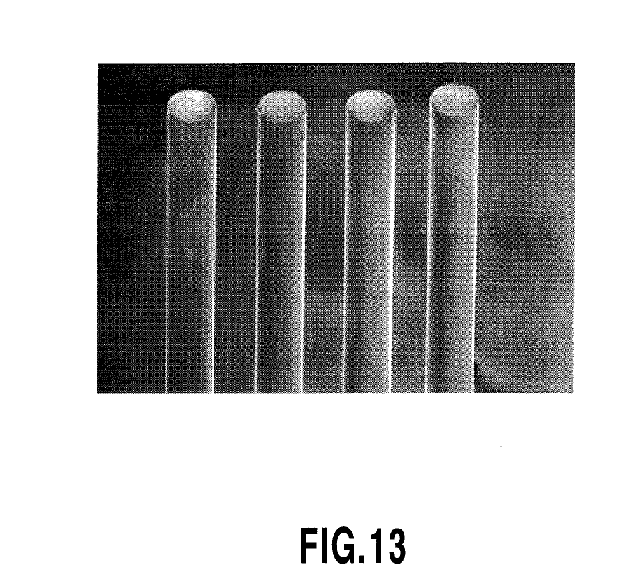

FIG. 13 is a photograph showing the bare optical fibers after the fiber surface cleaning of FIG. 5. It is found from the photograph that the residual coatings are removed, and the surfaces of the bare optical fibers are cleaned satisfactorily.

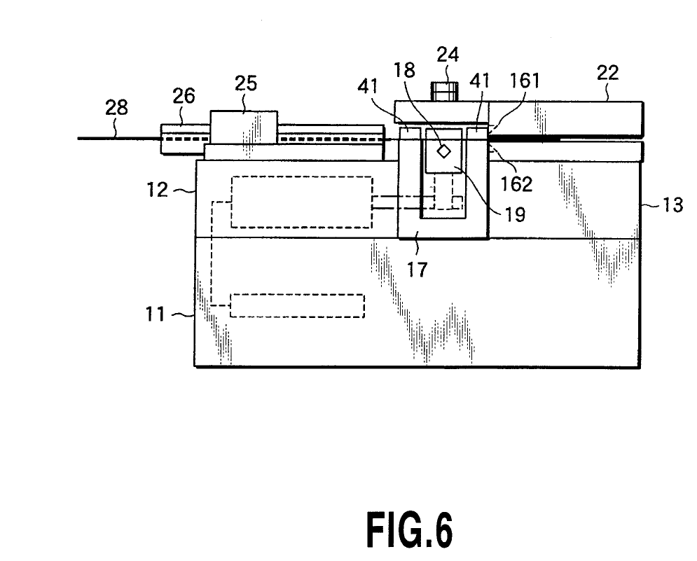

Next, as shown in FIG. 6, the clamp part 17 is inserted between the holder mounting section sliding part 12 and the fiber coating removal part 13, and the bare optical fibers removed the coating are clamped using a clamping component 41.

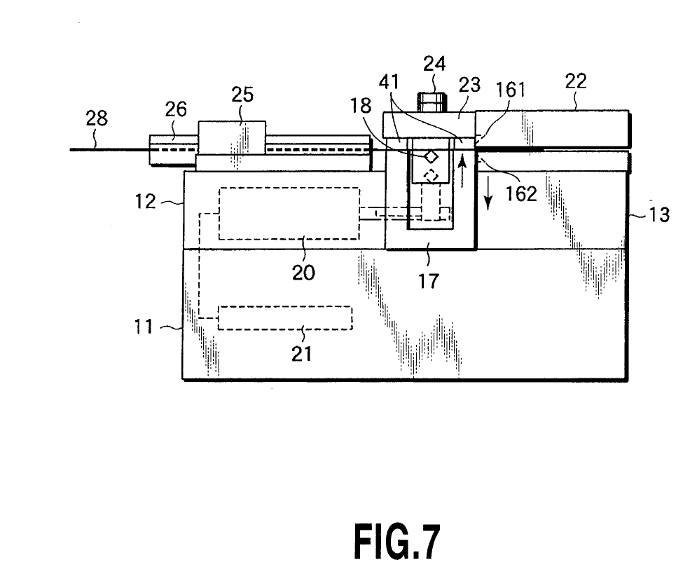

Next, as shown in FIG. 7, the heat source 18 is further lifted towards the clamped bare optical fibers to maintain the condition in which the heat source 18 is brought into contact to the bottom of the bare optical fibers, and carries out heating for a fixed time period. As for the movement of the heat source 18, since the heating for a fixed time is required, a preset program is installed in the electric circuit 21 so that by pushing a switch (not shown), the heat source 18 performs the vertical movement automatically via the heating section vertically driving motor 20, and the power supply of the heat source 18 is turned off after completing the heating.

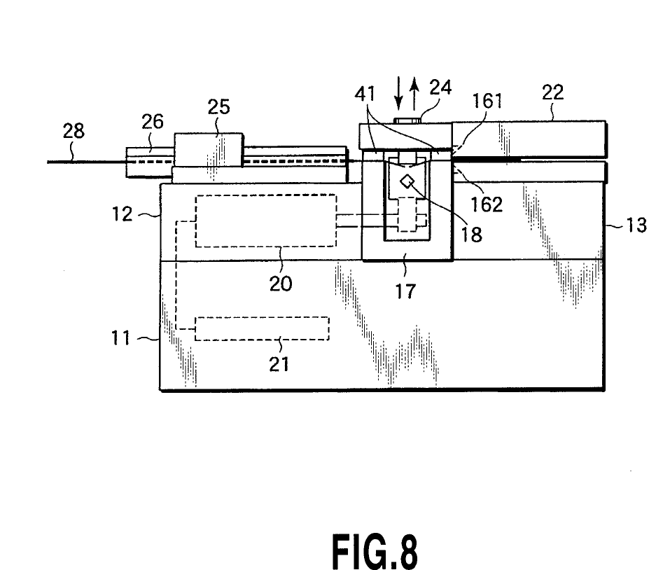

Next, as shown in FIG. 8, after completing the heating of the clamped bare optical fibers, the stress applying component 24 is pushed down with the cover 22 being pressed. Thus, the bending stress is applied to the top of the bare optical fibers to cut them by the thermal stress.

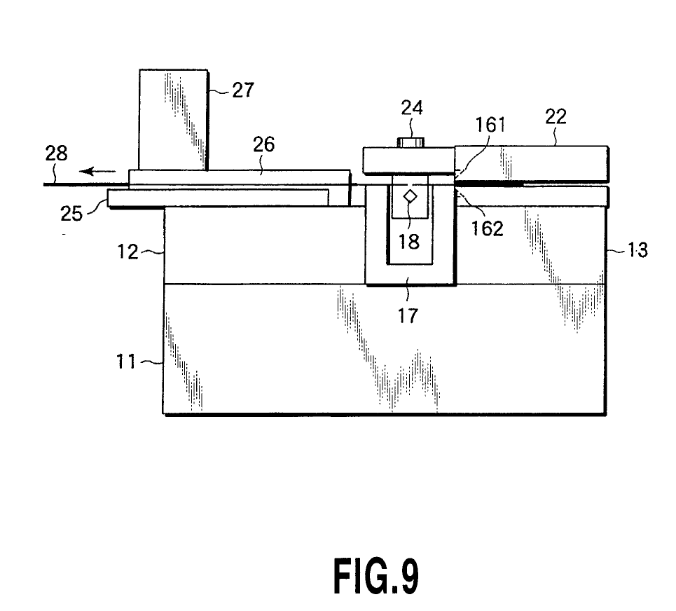

Next, as shown in FIG. 9, the clamping component 41 is released, and the clamp part 17 is extracted from between the holder mounting section sliding part 12 and the fiber coating removal part 13. After that, the holder mounting section upper cover 27 is opened to take out the coated fiber holder 26. Then the upper cover 32 of the coated fiber holder 26 is opened to take out the fiber ribbon 28. Thus, the endface preparation of the fiber ribbon 28 is completed, and the flat endfaces required for splicing the optical fibers of the fiber ribbon 28 are obtained.

After that, the endfaces of the optical fibers of the fiber ribbon 28 are joined to each other by such method as the mechanical splice, MT connector or fusion splice.

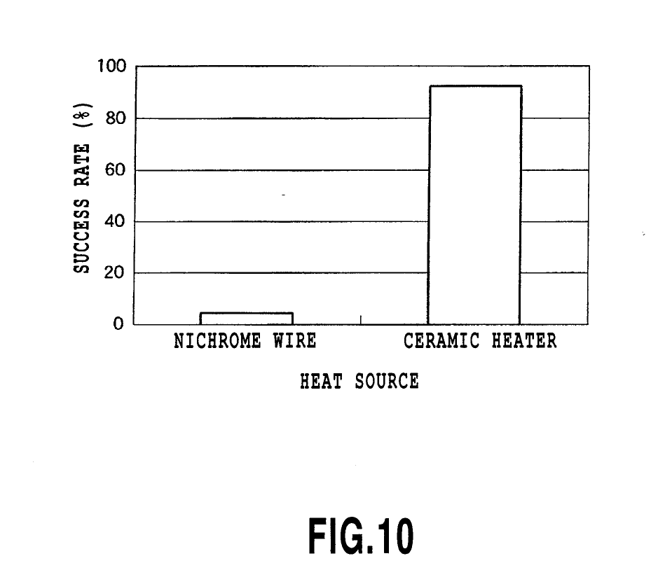

FIG. 10 is a characteristic diagram illustrating the cutting success rate of the bare optical fibers that undergo the endface preparation by the fiber endface preparation tool of the embodiment in accordance with the present invention as compared with Nichrome wire example. More specifically, with regard to a 4-fiber ribbon, the cutting success rate when the thermal cutting is carried out by using the ceramic heater used as the heat source is compared with the cutting success rate when the thermal cutting is carried out by using the Nichrome wire used as the heat source. In addition, the cutting success rate, which decides as the cutting success when the four coated fibers in 4-fiber ribbon are set on the fusion splice machine and are fusion spliced satisfactory.

FIG. 10 illustrates the success rates when the fiber endface preparations of 4-fiber ribbon were carried out. The cutting success rate is 90% or more when the ceramic heater is used as the heat source 18 of the embodiment in accordance with the present invention. In contrast, the cutting success rate is 10% or less when the Nichrome wire is used as the heat source. Thus, it is found that the present invention has a great advantage in the cutting success rate.

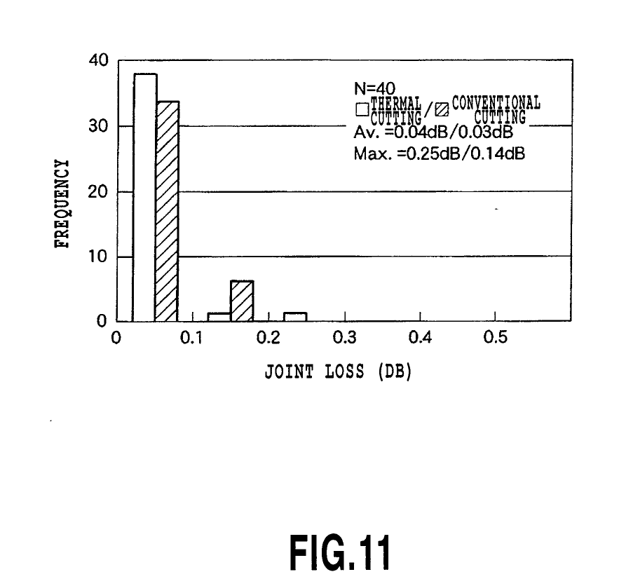

FIG. 11 is a characteristic diagram illustrating the fusion splice losses using 4-fiber ribbon that undergo the endface preparation by the fiber endface preparation tool of the embodiment as compared with those of the conventional example. More specifically, the fusion splice losses of 4-fiber ribbon measurement result when the cutting is carried out by using the ceramic heater is compared with the joint losses measurement result when the cutting is carried out by using the blade of the conventional optical fiber cutter.

As a result, we found that the endface preparation method based on the cutting (thermal cutting) by thermal stress in accordance with the present invention (10 splice using 4-fiber ribbon, average loss: 0.04 dB, maximum loss: 0.25 dB) has basic performance equivalent to the endface preparation method based on the cutting (conventional cutting) with the blade using the conventional optical fiber cutter (10 splice using 4-fiber ribbon, average loss: 0.03 dB, maximum loss: 0.14 dB).

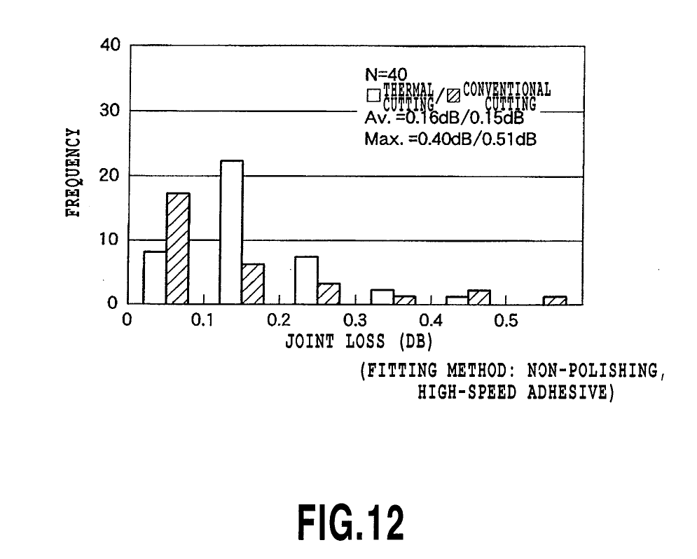

FIG. 12 is a characteristic diagram illustrating the connection losses of MT connector losses using 4-fiber ribbon that undergo the endface preparation by the fiber endface preparation tool of the embodiment in accordance with the present invention as compared with those of the conventional example. More specifically, the connection losses measurement result of MT connector using 4-fiber ribbon when the cutting is carried out by using the ceramic heater is compared with the joint losses measurement result when the cutting is carried out by using the blade of the conventional optical fiber cutter. The MT connector is assembled using a high-speed hardening adhesive and a non-polishing method having an influence on the fiber endface.

As a result, we found that the endface preparation method based on the cutting (thermal cutting) by thermal stress in accordance with the present invention (10 connection using 4-fiber ribbon, average loss: 0.16 dB, maximum loss: 0.40 dB) has basic performance equivalent to the endface preparation method based on the cutting (conventional cutting) with the blade using the conventional optical fiber cutter (10 connection using 4-fiber ribbon, average loss: 0.15 dB, maximum loss: 0.51 dB).

In order to realize the efficient joints for fiber ribbons, the fiber endface preparation tool of the embodiment in accordance with the present invention employs the heat source that does not change its shape by heating the heat source of the endface preparation tool. Thus, the ceramic heater that does not change its shape by heating is used as the heat source. The ceramic heater, which has a heating element sandwiched between ceramics and undergoes sintering, has a structure resistant to deformation even at high temperature because it is covered with ceramics. For example, a ceramic heater that has Nichrome wire or tungsten wire embedded in the ceramics is used as the heat source capable of achieving high temperature (above 1000° C.) in a small size with suppressing deformation. Applying the heat source consisting of the ceramic heater to the simplified integrated fiber endface preparation tool makes it possible to fabricate a tool of practical use which can suppress the deformation of the heat source, cut the coated optical fiber endfaces stably, and join them at a low loss.

As described above, the coated fiber endface preparation tool of the embodiment in accordance with the present invention can increase the success rate of the cutting. This is because the heat source consisting of the ceramic heater does not alter its shape when it is heated, and hence can apply its heat uniformly to the plurality of coated optical fibers of the fiber ribbon when cutting the plurality of coated optical fibers of the fiber ribbon. In addition, since the residual coatings sticking to the bare optical fibers are burned down by heating, the cutting and surface cleaning of the bare optical fibers are carried out simultaneouslytting and fiber surface cleaning of the optical fibers. Accordingly, it is possible to reduce the fiber endface preparation time.

Furthermore, the present invention is not limited to the foregoing embodiment itself, but can be materialized by varying the components within the essentials thereof at the implementation. Besides, the invention can be implemented in a variety of forms by appropriately combining the plurality of components disclosed in the foregoing embodiment. For example, some components can be eliminated from all the components of the embodiment. In addition, the components of the different embodiments can be combined appropriately.

Next, in order to obtain the stable fiber endface cutting using thermal stress, the heating condition is investigated experimentally based on a theoretical relationship between the temperature and heating time of the heat source. First, the amount of heat J transferred from the heat source to the bare optical fibers is given by the following expression (1).

J=ηqt=ηhsΔTₕt (1)

where η is efficiency of thermal energy which transmitted the fiber, q is a thermal flux, t is the heating time, h is the coefficient of heat transmission, s is the surface area of the heat source, and ΔTₕ is the temperature increase of the heat part of the heat source. Here, the temperature increase ΔTₕ of the heating part of the heat source is expressed as ΔTₕ=Tₛ−T₀ by the pre-heating source temperature T₀ (=ambient temperature) and the post-heating heat source temperature Tₛ.

On the other hand, the thermal stress σₜₕ applied to the bare optical fibers is given by the following expression (2).

$$\begin{matrix}{σ}_{th} = EKa Δ {T}_{G} \\ = EKaJ / ( c \cdot m ) \\ = EKa η hs Δ {T}_{h} t / ( c \cdot m )\end{matrix} \qquad ( 2 )$$

where E is the Young's modulus of the fiber, K is a coefficient dependent on clamping force, a is a coefficient of linear expansion of the fiber, ΔT_{G} is a temperature increase of the heating part of the fiber, c is the specific heat of the fiber, and m is the mass of the fiber. Since the coefficients other than ΔTₕ are values proper to the substances and are determined uniquely, when they are denoted by a constant A, the following expression (3) is given.

σₜₕ≈ΔTₕt (3)

From expression (3), it is found that the produced thermal stress of the fiber is largely depended on the product of the fiber contact time and temperature increase.

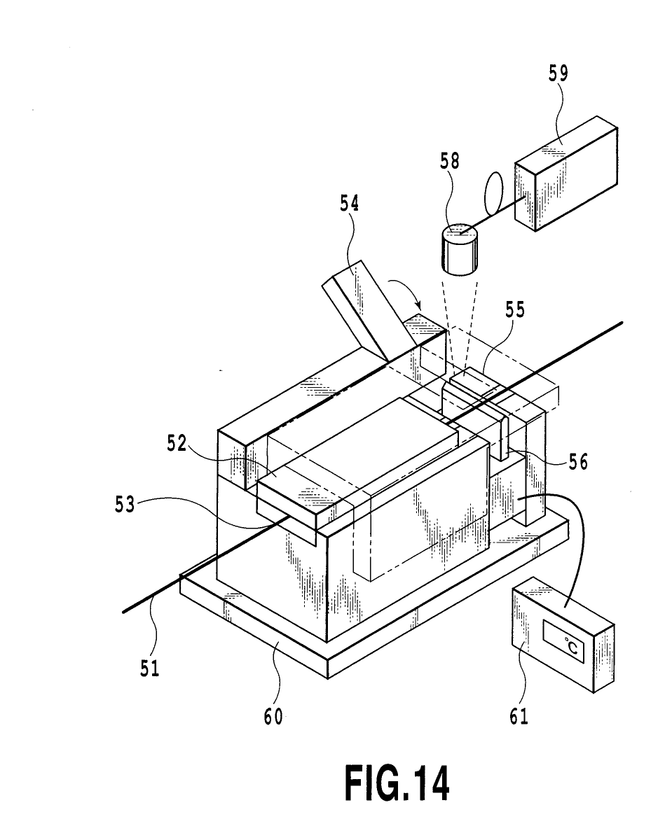

FIG. 14 shows the optical fiber cutting tool used in the experiment of the thermal fiber endface cutting carried out based on the expressions (1)-(3). The tool has on a base board 60 a holder mounting section 53 on which a coated fiber holder 52 is set in which coated optical fiber 51 with bare optical fiber part are set; a clamp section 55 for holding the bare optical fiber part of the coated optical fiber 51; and a heat source 56 placed at its center for heating the bare optical fiber part. As the heat source 56, was used a ceramic heater whose temperature is adjustable with a temperature regulator 61. The measurement was conducted with reading the temperature of the heat source 56 with a temperature sensor 58 consisting of a noncontact infrared radiation thermometer while viewing a temperature display 59.

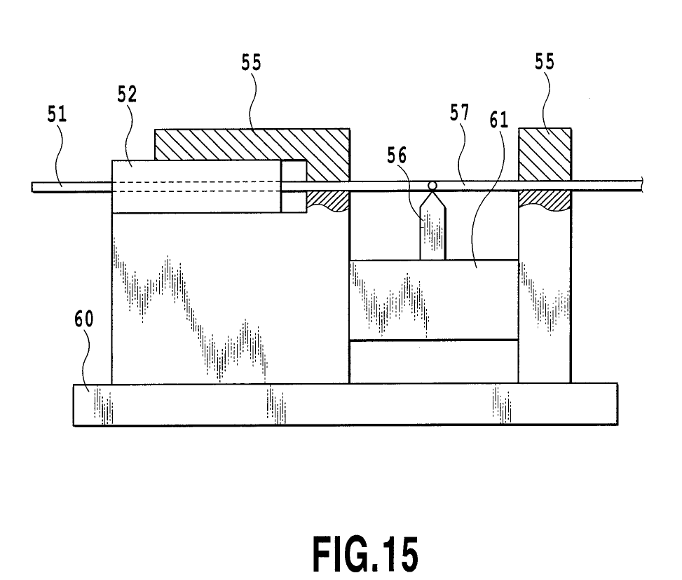

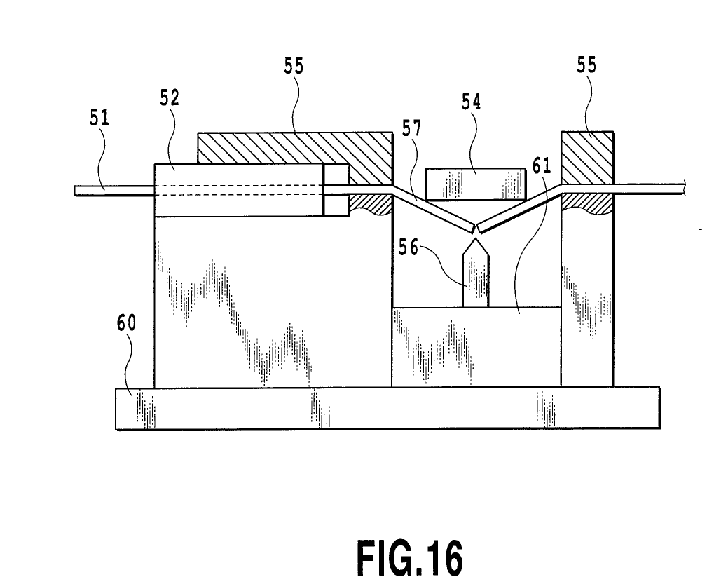

FIG. 15 shows a state before cutting in the experiment, and FIG. 16 shows a state after cutting in the experiment. The coated optical fiber 51 that had undergone the coating removal in advance were set in the coated fiber holder 52, and the heat source 56 was brought into contact with the bare optical fibers 57 of the coated optical fiber 51 at the center of the clamp section 55 to produce a thermal stress load. After that, further stress was applied by pushing from the opposite side with the stress applying plate 54 to cut the fiber. The temperature of the heat source 56 was in a range 800° C.-1100° C. and the heating time was measured at intervals of one second. In addition, the endface quality was checked using the endface inspection function of the fusion splice machine. 20 fibers were cut under each condition and the cutting success rate during was obtained in trems of success cut fibers

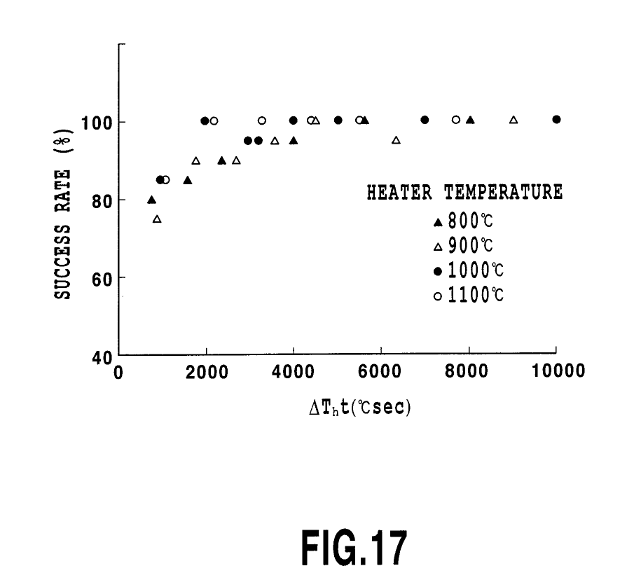

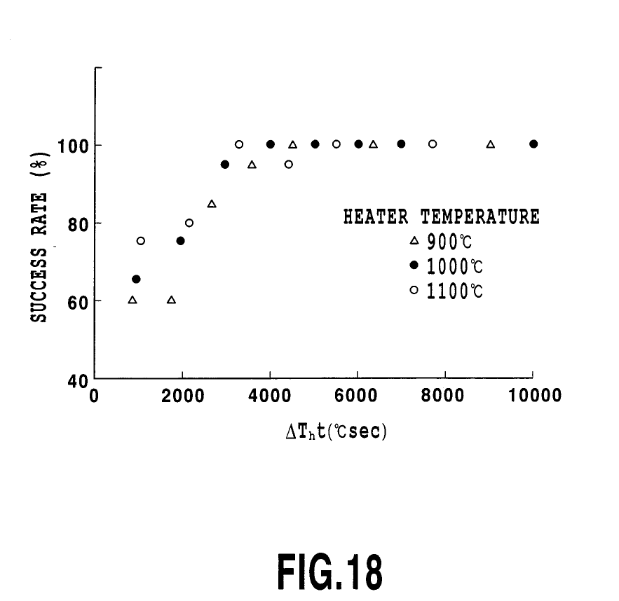

FIG. 17 illustrates cutting success rates when measured using a mono coated optical fiber; and FIG. 18 illustrates cutting success rates measured using a 4-fiber ribbon. The vertical axes represent the cutting success rates and the horizontal axes represent a product of the temperature and heating time of the heat source. As for both the mono coated optical fiber and 4-fiber ribbon, the cutting success rates are closely related to ΔTₕt: the success rates increase with an increase of ΔTₕt, and saturate at nearly 100% when ΔTₕt exceeds 3000° C. sec. Accordingly, in order to obtain the stable fiber endface, it is necessary to adjust the heating conditions of the optical fiber in such a manner that ΔTₕt becomes 3000° C. sec or more. In addition, it is necessary to reduce the heating time and to operate the heat temperature for efficient fiber cutting. Therefore, fiber cutting can be achieved efficiently when, for example, the heat source at 1000° C. and the heating time at about four seconds, respectively.

In this way, in the optical fiber cutting method using the thermal stress, the high success rate cutting of the optical fiber becomes possible if the product ΔTₕt of the temperature increase and heating time of the heat source exceeds 3000° C. sec.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An optical fiber cutting method comprising a cutting step of cutting the bare optical fiber with the thermal stress by using a heat source composed of a ceramic heater after the fiber coating removal and fiber surface cleaning.

2. The optical fiber cutting method as claimed in claim 1, wherein said ceramic heater consists of a heating element embedded in ceramics.

3. The optical fiber cutting method as claimed in claim 1, wherein said ceramic heater consists of Nichrome wire or tungsten wire embedded in ceramics.

4. The optical fiber cutting method as claimed in claim 1, wherein the cutting step comprises:
a heating step of heating a prescribed local area of the bare optical fiber by said heat source composed of the ceramic heater; and
a pressurizing step of further applying bending or tension stress on the prescribed local area of the bare optical fiber to carry out cutting, which the prescribed local area is provided the thermal stress by said heating step.

5. The optical fiber cutting method as claimed in claim 1, wherein a product of a temperature and heating time of said heat source is 3000° C. sec or more.

6. The optical fiber cutting method as claimed in claim 2, wherein a product of a temperature and heating time of said heat source is 3000° C. sec or more.

7. The optical fiber cutting method as claimed in claim 3, wherein a product of a temperature and heating time of said heat source is 3000° C. sec or more.

8. The optical fiber cutting method as claimed in claim 4, wherein a product of a temperature and heating time of said heat source is 3000° C. sec or more.

9. An optical fiber cutting tool comprising:
a fiber holder for clamping a bare optical fiber;
a clamp section set and held in said fiber holder for clamping the bare optical fiber after the fiber coating removal and fiber surface cleaning;
a heat source composed of a ceramic heater placed a prescribed local area of the bare optical fiber clamped by said clamp section; and
a stress component for further applying bending or tension stress on the prescribed local area of the bare optical fiber, which the prescribed local area is provided the thermal stress by said heat source composed of the ceramic heater.

10. The optical fiber cutting tool as claimed in claim 9, wherein said ceramic heater consists of a ceramic heater having a heating element embedded in ceramics.

11. The optical fiber cutting tool as claimed in claim 9, wherein said ceramic heater consists of a ceramic heater having Nichrome wire or tungsten wire embedded in ceramics.

12. The optical fiber cutting tool as claimed in claim 9, wherein a product of a temperature and heating time of said heat source is 3000° C. sec or more.

13. The optical fiber cutting tool as claimed in claim 10, wherein a product of a temperature and heating time of said heat source is 3000° C. sec or more.

14. An optical fiber endface preparation method comprising:
a coating removal step of removing a coating of a coated optical fiber to obtain a bare optical fiber;
a cutting step of cutting the bare optical fiber with the thermal stress by using a heat source composed of a ceramic heater.

15. The optical fiber endface preparation method as claimed in claim 14, wherein said ceramic heater consists of a heating element embedded in ceramics.

16. The optical fiber endface preparation method as claimed in claim 14, wherein said ceramic heater consists of Nichrome wire or tungsten wire embedded in ceramics.

17. The optical fiber endface preparation method as claimed in claim 14, wherein the coating removal step comprises:
a fiber coating heating step to heat the fiber coating for stripping easily; and
a strip step for stripping a coating of the coated optical fiber with a blade.

18. The coated optical fiber endface preparation method as claimed in claim 15, wherein the coating removal step comprises:
a fiber coating heating step to heat the fiber coating for stripping easily; and
a strip step for stripping a coating of the coated optical fiber with a blade.

19. The coated optical fiber endface preparation method as claimed in claim 16, wherein the coating removal step comprises:
a fiber coating to heat step of heating the fiber coating for stripping easily; and
a strip step for stripping a coating of the coated optical fiber with a blade.

20. The optical fiber endface preparation method as claimed in claim 14, wherein the cutting step comprises:
a heating step of heating a prescribed local area of the bare optical fiber by said heat source composed of the ceramic heater; and
a pressurizing step of further applying bending or tension stress on the prescribed local area of the bare optical fiber to carry out cutting, which the prescribed local area is provided the thermal stress by said heating step.

21. The optical fiber endface preparation method as claimed in claim 14, wherein a product of a temperature and heating time of said heat source is 3000° C. sec or more.

22. An optical fiber endface preparation tool comprising:
a fiber holder for clamping a coated optical fiber;
a base having a sliding section for sliding said fiber holder in an axial direction of the coated optical fiber;
a heating section which is set for heating the fiber coating removal portion of the coated optical fiber for removing easily;
a blade which is set for removing the fiber coating which is heated by said heating section;
a clamp section which is set for clamping the bare optical fiber which is removed the fiber coating of the coated optical fiber by said blade;
a heat source composed of a ceramic heater which is set for heating a prescribed local area of the bare optical fiber clamped by said clamp section; and
a stress component for further applying bending or tension stress on the heated section of the bare optical fiber whose prescribed section is heated by said heat source composed of the ceramic heater, which the prescribed local area is provided the thermal stress by said heat source composed of the ceramic heater.

23. The optical fiber endface preparation tool as claimed in claim 22, wherein said ceramic heater consists of a ceramic heater having a heating element embedded in ceramics.

24. The optical fiber endface preparation tool as claimed in claim 22, wherein said ceramic heater consists of a ceramic heater having Nichrome wire or tungsten wire embedded in ceramics.

25. The optical fiber endface preparation tool as claimed in claim 22, wherein a product of a temperature increase and heating time of said heat source is 3000° C. sec or more.
